(19) United States
(12) Patent Application Publication
(10) Pub. No.: US 2026/0221146 A1
(43) Pub. Date: Jul. 30, 2026

(54) SPEECH SIGNAL PROCESSING METHOD AND RELATED DEVICE

(71) Applicant: HUAWEI TECHNOLOGIES CO., LTD., Shenzhen (CN)

(72) Inventors: Libin Zhang, Beijing (CN); Zhibin Ma, Shanghai (CN); Zhihua Yang, Beijing (CN); Hui Yang, Beijing (CN)

(73) Assignee: HUAWEI TECHNOLOGIES CO., LTD., Shenzhen (CN)

(21) Appl. No.: 19/573,417

(22) Filed: Mar. 20, 2026

Related U.S. Application Data
(63) Continuation of application No. PCT/CN2024/118421, filed on Sep. 12, 2024.

(30) Foreign Application Priority Data
Sep. 22, 2023 (CN) 202311242905.5

(51) Int. Cl. G10L 21/0208; G10L 21/0216

(52) U.S. Cl. CPC G10L 21/0208; G10L 2021/02163

(57) ABSTRACT

A speech signal processing method is described. A first speech signal captured by a first pickup unit is obtained, where the first speech signal includes an environmental noise signal. While a voice service is performed using a second speech signal captured by a second pickup unit of the wearable device, a first duration based on the first speech signal is obtained, where the first duration is a duration in which noise energy of the environmental noise signal is continuously greater than a first energy threshold currently. Whether switching to using a third speech signal captured by a third pickup unit of the wearable device to perform the voice service is determined using the first duration, where when the noise energy of the environmental noise is greater than the first energy threshold, a signal-to-noise ratio of the third speech signal is greater than a signal-to-noise ratio of the second speech signal.

### CROSS-REFERENCE TO RELATED APPLICATIONS

This application is a continuation of International Application No. PCT/CN2024/118421, filed on Sep. 12, 2024, which claims priority to Chinese Patent Application No. 202311242905.5, filed on Sep. 22, 2023. The disclosures of the aforementioned applications are hereby incorporated by reference in their entireties.

### TECHNICAL FIELD

This application relates to the field of acoustic technologies, and in particular, to a speech signal processing method and a related device.

### BACKGROUND

During a call, a microphone on an electronic device is generally intended to capture a clear speech signal, so as to ensure call quality. However, a real-world environment is usually complex, and especially in a scenario with relatively high environmental noise such as a roadside, a workshop, or factory and mining areas, environmental noise is extremely high, which poses a relatively high challenge to a clear call of a headset.

A bone conduction microphone can effectively pick up a speech signal in a high-noise environment, and can be used in the high-noise environment to ensure call quality. An operating principle of the bone conduction microphone is as follows: When a person speaks, the skin and jawbone vibrate, and the bone conduction microphone picks up vibration signals of the skin and jawbone and converts the signals into speech signals.

However, the speech signals captured by the bone conduction microphone are severely distorted, and human speech clarity is relatively poor, resulting in limited application scenarios. Therefore, there is an urgent need for a technical solution that can take various noise scenarios into account, so that clear sound pickup and a clear call can be ensured for a headset in various complex noise scenarios.

### SUMMARY

This application provides a speech signal processing method and a related device, to resolve a problem that a related technology can hardly ensure that a headset obtains a stable speech signal with a high signal-to-noise ratio in a complex noise scenario.

A first aspect provides a speech signal processing method. The method includes: obtaining a first speech signal captured by a first pickup unit, where the first speech signal includes an environmental noise signal, the environmental noise signal indicates environmental noise of an environment in which a wearable device is located, the first pickup unit is a pickup unit configured to capture environmental noise, and the environmental noise in the first speech signal can accurately represent an environmental noise status of the environment in which the wearable device is located; while performing a voice service by using a second speech signal captured by a second pickup unit of the wearable device, obtaining first duration based on the first speech signal, where the first duration is duration in which noise energy of the environmental noise signal is continuously greater than a first energy threshold currently; and determining, based on the first duration, whether to switch to using a third speech signal to perform the voice service, where the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

At least two different pickup units are disposed on the wearable device, and the third pickup unit has a higher signal-to-noise ratio in a high-noise environment. The first duration in which the environmental noise energy in the current environment is continuously in a state of being greater than the first energy threshold is obtained based on the first speech signal. Therefore, whether the current environment is a high-noise environment or a low-noise environment can be determined based on the first duration, whether the environmental noise is stably in a high-noise state can be determined, and further, a speech signal used to perform the voice service can be adaptively switched based on the first duration, to ensure a relatively high signal-to-noise ratio of each speech signal and speech clarity and stability in a complex environment, and ensure stability of the voice service.

In a possible embodiment, determining, based on the first duration, whether to switch to using the third speech signal to perform the voice service includes: when the first duration is greater than a first duration threshold, determining to switch to using the third speech signal to perform the voice service; or when the first duration is less than or equal to a first duration threshold, determining to still use the second speech signal to perform the voice service.

If the first duration is greater than the first duration threshold, it indicates that the environment is currently in a relatively stable high-noise state, and the speech signal used to perform the voice service may be switched to the third speech signal with a higher signal-to-noise ratio in the environment, thereby improving speech clarity and ensuring stability of the voice service. If the first duration is less than or equal to the first duration threshold, it indicates that the environmental noise is currently still in an unstable state. To avoid frequent switching between speech signals, switching may not be performed temporarily, and the currently used speech signal is maintained.

In a possible embodiment, determining, based on the first duration, whether to switch to using the third speech signal to perform the voice service includes: determining, based on the first duration and second duration, whether to switch to using the third speech signal to perform the voice service, where the second duration is duration in which the voice service is continuously performed by using the second speech signal currently.

Because the duration in which the voice service is continuously performed by using the second speech signal currently is included in a switching condition, frequent switching between speech signals can be avoided, and stability of the voice service can be improved.

In a possible embodiment, determining, based on the first duration and the second duration, whether to switch to using the third speech signal to perform the voice service includes: when the first duration is greater than the first duration threshold, and the second duration is greater than a second duration threshold, determining to switch to using the third speech signal to perform the voice service; or when the first duration is less than or equal to the first duration threshold, and/or the second duration is less than or equal to a second duration threshold, determining to still use the second speech signal to perform the voice service. In some embodiments, the second duration threshold is greater than the first duration threshold.

The speech signal is switched when the first duration is greater than the first duration threshold and the second duration is greater than the second duration threshold. After the environmental noise is stable and the voice service is performed for a period of time by using the second duration threshold, the speech signal is switched. This can avoid frequent switching between speech signals and ensure stability of the voice service, and switching to a speech signal with a higher signal-to-noise ratio can improve quality of the voice service.

In a possible embodiment, the method further includes: while performing the voice service by using the third speech signal, obtaining third duration based on the first speech signal, where the third duration is duration in which the noise energy of the environmental noise signal is continuously less than or equal to a second energy threshold currently, and the second energy threshold is less than or equal to the first energy threshold; and determining, based on the third duration, whether to switch to using the second speech signal to perform the voice service, where when the noise energy of the environmental noise is less than or equal to the second energy threshold, the signal-to-noise ratio of the second speech signal is greater than the signal-to-noise ratio of the third speech signal.

In a possible embodiment, determining, based on the third duration, whether to switch to using the second speech signal to perform the voice service includes: when the third duration is greater than a third duration threshold, determining to switch to using the second speech signal to perform the voice service; or when the third duration is less than or equal to a third duration threshold, determining to still use the third speech signal to perform the voice service.

In a possible embodiment, determining, based on the third duration, whether to switch to using the second speech signal to perform the voice service includes: determining, based on the third duration and fourth duration, whether to switch to using the third speech signal to perform the voice service, where the fourth duration is duration in which the voice service is continuously performed by using the third speech signal currently.

In a possible embodiment, determining, based on the third duration and the fourth duration, whether to switch to using the third speech signal to perform the voice service includes: when the third duration is greater than a third duration threshold, and the fourth duration is greater than a fourth duration threshold, determining to switch to using the second speech signal to perform the voice service; or when the third duration is less than or equal to a third duration threshold, and/or the fourth duration is less than or equal to a fourth duration threshold, determining to still use the third speech signal to perform the voice service.

In a possible embodiment, the method further includes: obtaining a forced switching instruction, where the forced switching instruction instructs to use a target speech signal to perform the voice service, and the target speech signal is one of the second speech signal and the third speech signal; and when a speech signal currently used to perform the voice service is different from the target speech signal, switching to using the target speech signal to perform the voice service.

In some embodiments, a user is allowed to forcibly switch a speech signal used to perform the voice service, so that switching is more flexible and can better adapt to a user requirement.

In a possible embodiment, after switching to using the target speech signal to perform the voice service, the method further includes: when the target speech signal is the second speech signal, obtaining fifth duration based on the first speech signal, and determining, based on the fifth duration, whether to switch to using the third speech signal to perform the voice service, where the fifth duration is duration in which the noise energy of the environmental noise signal is continuously greater than the first energy threshold currently; or when the target speech signal is the third speech signal, obtaining sixth duration based on the first speech signal, and determining, based on the sixth duration, whether to switch to using the second speech signal to perform the voice service, where the sixth duration is duration in which the noise energy of the environmental noise signal is continuously less than or equal to the second energy threshold currently. A combination of forced switching and adaptive switching can meet a user requirement and ensure stability of the voice service.

In a possible embodiment, the method further includes: when the voice service starts, obtaining initial noise energy of the environmental noise based on the first speech signal; and when the initial noise energy is greater than a fifth energy threshold, determining to use the third speech signal to perform the voice service; or when the initial noise energy is less than or equal to a fifth energy threshold, determining to use the second speech signal to perform the voice service. When the voice service starts, the speech signal used to perform the voice service is selected based on the initial noise energy. This can ensure that the speech signal has a relatively high signal-to-noise ratio at an initial stage of the voice service, and ensure quality of the voice service.

In a possible embodiment, the method further includes: extracting a non-speech segment in the first speech signal to obtain the environmental noise signal; and obtaining the noise energy of the environmental noise signal. A user speech signal may further exist in the first speech signal, and the non-speech segment extracted from the first speech signal is a relatively pure environmental noise signal, so that the environmental noise signal can accurately represent a current environmental noise status. Therefore, making a speech switching decision based on the environmental noise status is more timely and accurate.

In a possible embodiment, the first pickup unit is a pickup unit disposed on the wearable device; or the first pickup unit is a pickup unit disposed on an intelligent device connected to the wearable device.

In a possible embodiment, performing the voice service by using the second speech signal captured by the second pickup unit of the wearable device includes: performing noise reduction processing on the second speech signal by using the first speech signal, to obtain a denoised speech signal; and performing the voice service by using the denoised speech signal. The first speech signal can accurately represent the current environmental noise status. In addition, because the first speech signal and the second speech signal are captured in the same environment, performing noise reduction processing on the second speech signal by using the first speech signal can filter environmental noise in the second speech signal more accurately, thereby obtaining a denoised speech signal with a higher signal-to-noise ratio, improving speech clarity of the user, and ensuring quality of the voice service.

In a possible embodiment, the second pickup unit is an air conduction microphone, and the third pickup unit is a bone conduction microphone; or the second pickup unit is an omnidirectional air conduction microphone, and the third pickup unit is a directional air conduction microphone.

A second aspect provides a speech signal processing apparatus. The apparatus includes a processing module, and the processing module is configured to perform the speech signal processing method according to any one of the first aspect or the possible embodiments of the first aspect.

Specifically, the processing module is configured to obtain a first speech signal captured by a first pickup unit, where the first speech signal includes an environmental noise signal, and the environmental noise signal indicates environmental noise of an environment in which a wearable device is located. The first pickup unit is a pickup unit configured to capture environmental noise, and the environmental noise in the first speech signal can accurately represent an environmental noise status of the environment in which the wearable device is located. While performing a voice service by using a second speech signal captured by a second pickup unit of the wearable device, the processing module is configured to obtain first duration based on the first speech signal, where the first duration is duration in which noise energy of the environmental noise signal is continuously greater than a first energy threshold currently. The processing module is configured to determine, based on the first duration, whether to switch to using a third speech signal to perform the voice service, where the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

In a possible embodiment, the processing module is configured to: when the first duration is greater than a first duration threshold, determine to switch to using the third speech signal to perform the voice service; or when the first duration is less than or equal to a first duration threshold, determine to still use the second speech signal to perform the voice service.

In a possible embodiment, the processing module is configured to: determine, based on the first duration and second duration, whether to switch to using the third speech signal to perform the voice service, where the second duration is duration in which the voice service is continuously performed by using the second speech signal currently.

In a possible embodiment, the processing module is configured to: when the first duration is greater than the first duration threshold, and the second duration is greater than a second duration threshold, determine to switch to using the third speech signal to perform the voice service; or when the first duration is less than or equal to the first duration threshold, and/or the second duration is less than or equal to a second duration threshold, determine to still use the second speech signal to perform the voice service. In some embodiments, the second duration threshold is greater than the first duration threshold.

In a possible embodiment, the processing module is configured to: while performing the voice service by using the third speech signal, obtain third duration based on the first speech signal, where the third duration is duration in which the noise energy of the environmental noise signal is continuously less than or equal to a second energy threshold currently, and the second energy threshold is less than or equal to the first energy threshold; and determine, based on the third duration, whether to switch to using the second speech signal to perform the voice service, where when the noise energy of the environmental noise is less than or equal to the second energy threshold, the signal-to-noise ratio of the second speech signal is greater than the signal-to-noise ratio of the third speech signal.

In a possible embodiment, the processing module is configured to: when the third duration is greater than a third duration threshold, determine to switch to using the second speech signal to perform the voice service; or when the third duration is less than or equal to a third duration threshold, determine to still use the third speech signal to perform the voice service.

In a possible embodiment, the processing module is configured to determine, based on the third duration and fourth duration, whether to switch to using the third speech signal to perform the voice service, where the fourth duration is duration in which the voice service is continuously performed by using the third speech signal currently.

In a possible embodiment, the processing module is configured to: when the third duration is greater than a third duration threshold, and the fourth duration is greater than a fourth duration threshold, determine to switch to using the second speech signal to perform the voice service; or when the third duration is less than or equal to a third duration threshold, and/or the fourth duration is less than or equal to a fourth duration threshold, determine to still use the third speech signal to perform the voice service.

In a possible embodiment, the processing module is configured to: obtain a forced switching instruction, where the forced switching instruction instructs to use a target speech signal to perform the voice service, and the target speech signal is one of the second speech signal and the third speech signal; and when a speech signal currently used to perform the voice service is different from the target speech signal, switch to using the target speech signal to perform the voice service.

In a possible embodiment, the processing module is configured to: when the target speech signal is the second speech signal, obtain fifth duration based on the first speech signal, and determine, based on the fifth duration, whether to switch to using the third speech signal to perform the voice service, where the fifth duration is duration in which the noise energy of the environmental noise signal is continuously greater than the first energy threshold currently; or when the target speech signal is the third speech signal, obtain sixth duration based on the first speech signal, and determine, based on the sixth duration, whether to switch to using the second speech signal to perform the voice service, where the sixth duration is duration in which the noise energy of the environmental noise signal is continuously less than or equal to the second energy threshold currently. A combination of forced switching and adaptive switching can meet a user requirement and ensure stability of the voice service.

In a possible embodiment, the processing module is configured to: when the voice service starts, obtain initial noise energy of the environmental noise based on the first speech signal; and when the initial noise energy is greater than a fifth energy threshold, determine to use the third speech signal to perform the voice service; or when the initial noise energy is less than or equal to a fifth energy threshold, determine to use the second speech signal to perform the voice service. When the voice service starts, the speech signal used to perform the voice service is selected based on the initial noise energy. This can ensure that the speech signal has a relatively high signal-to-noise ratio at an initial stage of the voice service, and ensure quality of the voice service.

In a possible embodiment, the processing module is configured to: extract a non-speech segment in the first speech signal to obtain the environmental noise signal; and obtain the noise energy of the environmental noise signal. A user speech signal may further exist in the first speech signal, and the non-speech segment extracted from the first speech signal is a relatively pure environmental noise signal, so that the environmental noise signal can accurately represent a current environmental noise status. Therefore, making a speech switching decision based on the environmental noise status is more timely and accurate.

In a possible embodiment, the first pickup unit is a pickup unit disposed on the wearable device; or the first pickup unit is a pickup unit disposed on an intelligent device connected to the wearable device.

In a possible embodiment, the processing module is configured to: perform noise reduction processing on the second speech signal by using the first speech signal, to obtain a denoised speech signal; and perform the voice service by using the denoised speech signal. The first speech signal can accurately represent the current environmental noise status. In addition, because the first speech signal and the second speech signal are captured in the same environment, performing noise reduction processing on the second speech signal by using the first speech signal can filter environmental noise in the second speech signal more accurately, thereby obtaining a denoised speech signal with a higher signal-to-noise ratio, improving speech clarity of the user, and ensuring quality of the voice service.

In a possible embodiment, the second pickup unit is an air conduction microphone, and the third pickup unit is a bone conduction microphone; or the second pickup unit is an omnidirectional air conduction microphone, and the third pickup unit is a directional air conduction microphone.

A third aspect provides an electronic device. The electronic device includes a processor and a memory. The processor is coupled to the memory. The processor is configured to perform, based on instructions stored in the memory, the speech signal processing method according to any one of the first aspect or the embodiments of the first aspect.

In a possible embodiment, the electronic device is a wearable device, the electronic device further includes a second pickup unit and a third pickup unit, the second pickup unit is configured to capture a second speech signal, and the third pickup unit is configured to capture a third speech signal.

In a possible embodiment, the electronic device further includes a first pickup unit, and the first pickup unit is configured to capture a first speech signal.

A fourth aspect provides a computer-readable storage medium including instructions. When the computer-readable storage medium runs on a computer, the computer is enabled to perform the speech signal processing method according to any one of the first aspect or the embodiments of the first aspect.

### BRIEF DESCRIPTION OF DRAWINGS

FIG. 1a is a diagram of a real-time call between an air conduction microphone and a mobile phone according to embodiments of this application;

FIG. 1b-1 to FIG. 1b-3 are a diagram of a real-time call between a bone conduction microphone and a mobile phone according to embodiments of this application;

FIG. 2 is a diagram of a system architecture related to a speech signal processing method according to embodiments of this application;

FIG. 3 is a diagram of deployment of pickup units for a wearable device according to embodiments of this application;

FIG. 4 is a diagram of a structure of an electronic device according to embodiments of this application;

FIG. 5a is a diagram of a logical structure of an electronic device according to embodiments of this application;

FIG. 5b is a diagram of interaction between modules in FIG. 5a according to embodiments of this application;

FIG. 6 is a schematic flowchart of a speech signal processing method according to embodiments of this application;

FIG. 7 is a simulation diagram of speech switching performed based on a solution provided in this application, according to embodiments of this application; and

FIG. 8 is a diagram of a structure of a speech signal processing apparatus according to embodiments of this application.

### DESCRIPTION OF EMBODIMENTS

This application provides a speech signal processing method and a related device, to ensure voice quality of a voice service in a complex scenario.

The following describes embodiments of this application with reference to the accompanying drawings. It is clear that the described embodiments are merely some rather than all of the embodiments of this application. A person of ordinary skill in the art may know that, with development of technologies and emergence of a new scenario, the technical solutions provided in embodiments of this application are also applicable to a similar technical problem.

In the specification, claims, and accompanying drawings of this application, the terms “first”, “second”, and the like are intended to distinguish similar objects but do not necessarily indicate a specific order or sequence. In the descriptions of this application, unless otherwise specified, “a plurality of” means two or more than two.

The specific term “example” herein means “used as an example, embodiment, or illustration”. Any embodiment described as an “example” is not necessarily construed as being superior to or better than other embodiments.

In embodiments of this application, unless otherwise specified or there is a logic conflict, terms and/or descriptions between different embodiments are consistent and may be mutually referenced, and technical features in different embodiments may be combined into a new embodiment based on an internal logical relationship thereof.

In a voice scenario such as a call, voice interaction, recording, voice entertainment, or a video conference, a user sometimes wears a wearable device such as a headset, and uses the wearable device to capture a speech signal of the user, so that the wearable device or an electronic device connected to the wearable device can implement a related voice service based on the speech signal of the user. By using the wearable device to participate in the voice service, the user can free both hands of the user, so that the user can perform other activities at the same time. In addition, because the wearable device is relatively close to a sound source of the user and can pick up a speech signal with a higher signal-to-noise ratio, voice service quality is improved. Furthermore, a risk of user privacy leakage can be reduced, or impact on other persons can be reduced. This greatly facilitates work, and work, and study of the user.

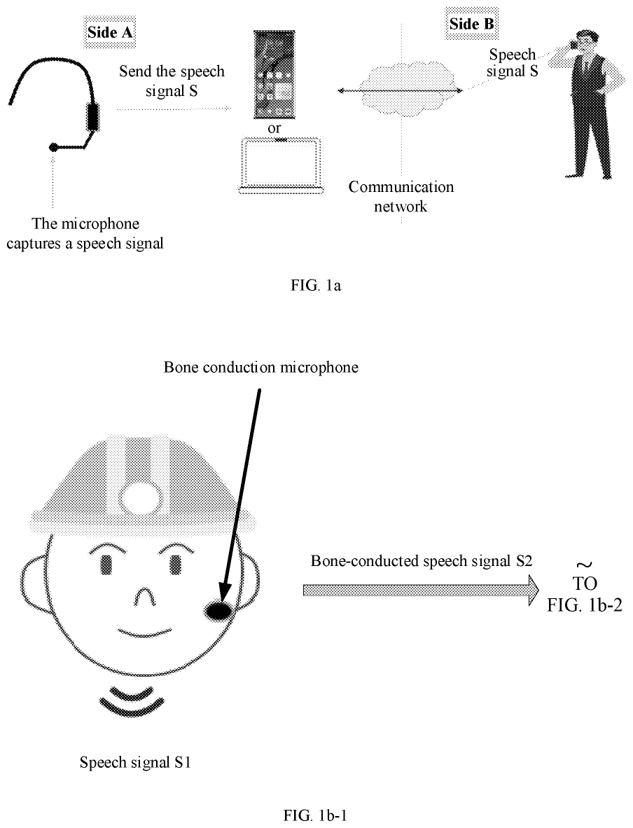

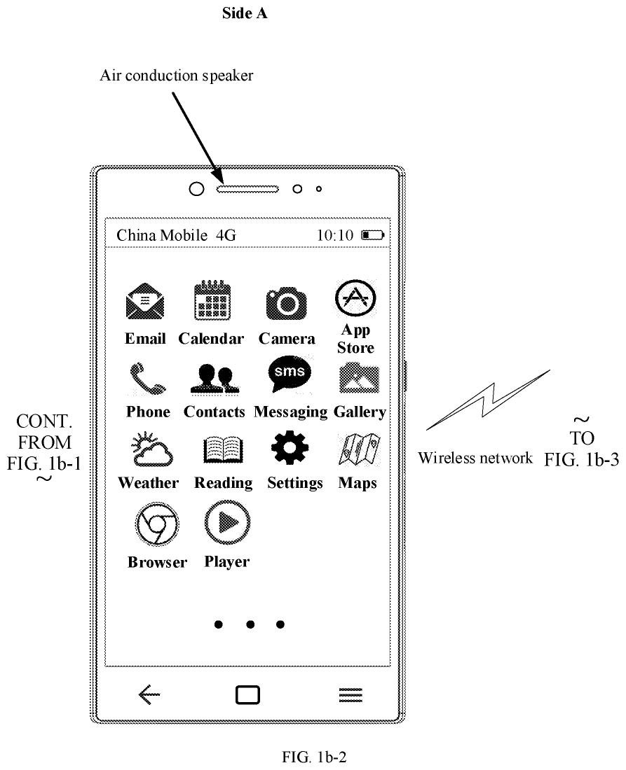

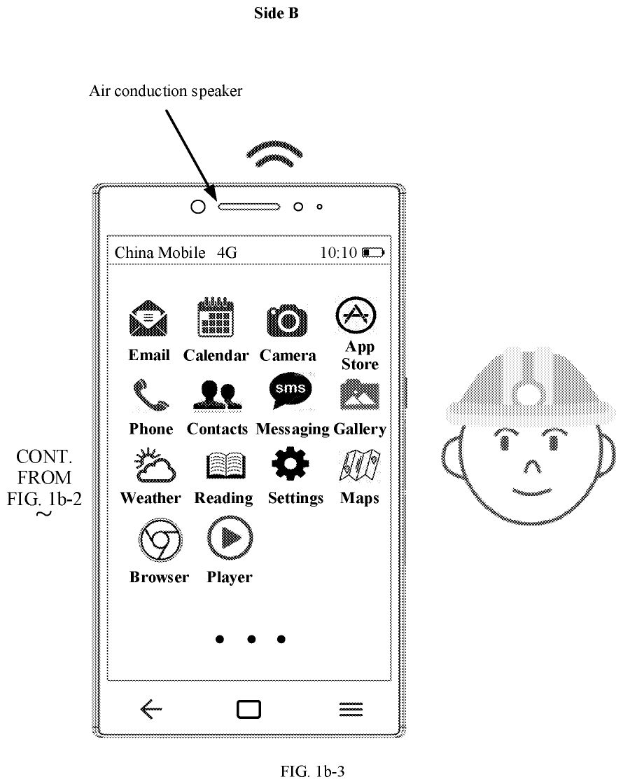

A call scenario is used as an example. In most cases, speech signals are transmitted through air conduction. A transmission process may be shown in FIG. 1a. A user on a side A performs a voice call with a user on a side B based on a wearable device (a headset is used as an example herein) and an electronic device (a mobile phone is used as an example herein, and the electronic device may alternatively be a computer, a tablet, or the like) connected to the wearable device. For example, the user on the side A speaks and the user on the side B listens. The transmission process is as follows: The user on the side A speaks and emits a speech signal S. Next, an air conduction microphone on the headset on the side A captures the speech signal S. Then, The headset on the side A sends the speech signal S to the mobile phone on the side A. The mobile phone on the side A then encodes and compresses the speech signal S and then transmits the signal to a mobile phone on the side B based on a wireless network. Next, the mobile phone on the side B decodes the received signal to restore the speech signal S. Then the mobile phone on the side B plays the speech signal S based on a speaker of the mobile phone on the side B (or a wearable device connected to the mobile phone on the side B).

During transmission of the air-conducted speech signal, in addition to a speech of the user on the side A, environmental noise is also captured in the speech signal S. If the environmental noise is high, a listening effect of the user on the side B is affected. Therefore, in some high-noise scenarios, such as a mine and rescue, a bone-conducted speech signal is generally used for information transmission because a bone conduction microphone captures less environmental noise and captures audio with a high signal-to-noise ratio. This can greatly ensure call efficiency in these scenarios. A transmission process is shown in FIG. 1b-1 to FIG. 1b-3. A user on a side A and a user on a side B perform a voice call based on mobile phones. For example, the user on the side A speaks and the user on the side B listens (it is assumed that the side B does not change). The transmission process is as follows: The user on the side A speaks and emits a speech signal S1. then, a bone conduction microphone on a head-mounted device (for example, a headset) on the side A is placed close to a face of the user on the side A, and captures an audio signal S2 (which may also be referred to as a bone-conducted speech signal S2) based on skin vibration when the user on the side A speaks. The bone-conducted speech signal S2 is sent (for example, sent through a Bluetooth connection between the head-mounted device and a mobile phone) to the mobile phone on the side A. Next, the mobile phone on the side A encodes and compresses the bone-conducted speech signal S2 and then transmits the signal to a mobile phone on the side B based on a wireless network. The mobile phone on the side B then decodes the received signal to restore the bone-conducted speech signal S2. Then, the mobile phone on the side B plays the bone-conducted speech signal S2 based on an air conduction speaker of the mobile phone on the side B.

Both a generation model for an air-conducted speech signal and a generation model for a bone-conducted speech signal are based on convolution of an excitation source and an excitation channel (Excitation source*Excitation channel=Speech signal). However, specific generation principles of the two are different. Both an excitation source of the air-conducted speech signal and an excitation source of the bone-conducted speech signal are vocal bands. However, an excitation channel of the air-conducted speech signal includes a pharyngeal cavity, an oral cavity, and the like; and an excitation channel of the bone-conducted speech signal includes muscles, bones, and the like. Because the excitation channels of the two are different, final listening experience differs greatly. Because the excitation channel of the air-conducted speech signal is air transmission, human voice distortion is small and clarity is high. However, because the air conduction microphone is sensitive to environmental noise, the air-conducted speech signal includes more environmental noise. The excitation channel of the bone-conducted speech signal is transmission through solid and soft tissues. Although a signal-to-noise ratio is relatively high, the bone-conducted speech signal exhibits greater distortion, lower brightness, and poorer listening comfort compared with the air-conducted speech signal. More severely, a speech on the side A heard by the peer side (for example, the side B) is unnatural. In severe cases, it may be difficult to distinguish who is speaking. This affects call efficiency.

Therefore, there is an urgent need for a technical solution that can take various noise scenarios into account, so that a clear and stable speech signal can be ensured in various complex noise scenarios.

To resolve the foregoing technical problem, this application provides the following technical solutions.

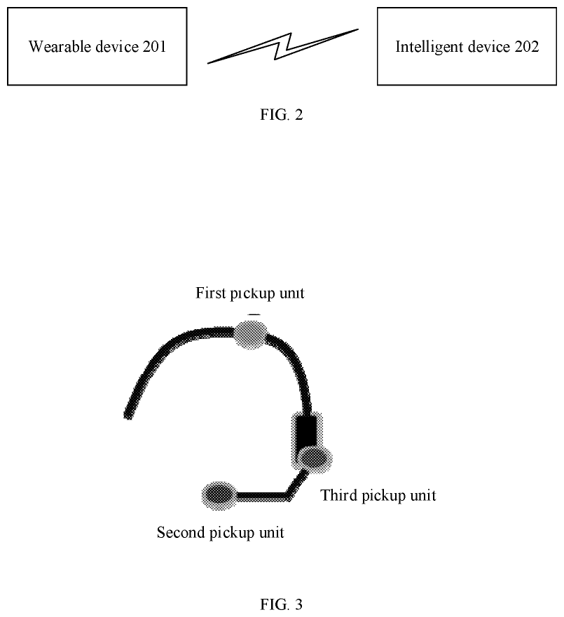

FIG. 2 is a diagram of a system architecture related to a speech signal processing method according to this application. With reference to FIG. 2, the system may include a wearable device 201 and an intelligent device 202. The wearable device 201 and the intelligent device 202 are connected in a wired or wireless manner to perform communication. The wireless manner may be specifically Bluetooth, a wireless local area network (WLAN), ZigBee, near field communication (NFC), or the like, or may be another next-generation wireless short-range communication technology, such as NearLink™. In an embodiment, the wearable device 201 may be a device such as a headset, smart glasses, an augmented reality (AR) head mounted display device, a virtual reality (VR) head mounted display device, or a neck massage apparatus. The intelligent device 202 may be a device such as a mobile phone, a tablet computer, a computer, or in-vehicle infotainment.

In this embodiment of this application, the wearable device 201 is configured to capture a speech signal, and send the captured speech signal to the intelligent device 202. The intelligent device 202 is configured to receive the speech signal sent by the wearable device 201, and perform a corresponding voice service based on the received speech signal. In this embodiment, the voice service may be a service related to speech signal processing, such as a call service, a voice interaction service, a recording service, a voice entertainment service (for example, Karaoke), and a video conference service.

The system includes a first pickup unit (or referred to as a pickup sensor, a microphone, or the like) configured to capture an environmental sound signal of an environment in which the wearable device 201 is located. In a possible embodiment, the first pickup unit may be a pickup unit disposed on the wearable device 201. In another possible embodiment, the first pickup unit may alternatively be a pickup unit disposed on the intelligent device 202. Because the wearable device 201 and the intelligent device 202 are relatively close to each other, and the wearable device 201 and the intelligent device 202 are in the same environment, an environmental sound signal captured by the pickup unit on the intelligent device 202 may be considered as an environmental sound signal of the environment in which the wearable device 201 is located. In addition, because the intelligent device 202 is at a distance from a user sound source, a quantity of user speech signals in captured environmental sound signals is relatively small and can accurately indicate a noise status in the environment. In some embodiments, in a possible embodiment, the system further includes another device that is in the same environment and that is connected to the intelligent device, for example, a wearable device (for example, a smartwatch), an intelligent device (a tablet computer or a notebook computer), or an Internet of Things device (a smart appliance, a smart toy, a smart robot, or an industrial Internet of Things device). The first pickup unit may be a pickup unit on the another device.

When the first pickup unit is a pickup unit on the wearable device 201, the first pickup unit may be a bone conduction microphone, or may be an air conduction microphone. In some embodiments, the first pickup unit may be deployed toward an external environment, away from a human voice source, to capture more accurate environmental noise. When the first pickup unit is a pickup unit on the intelligent device 202, the first pickup unit may be an air conduction microphone. Certainly, when the first pickup unit is a pickup unit on the intelligent device 202, the first pickup unit may also be a bone conduction microphone.

The wearable device 201 includes at least two pickup units, for example, includes a second pickup unit and a third pickup unit. The second pickup unit and the third pickup unit are different pickup units. In a low-noise environment, a signal-to-noise ratio of a speech signal captured by the second pickup unit is higher than a signal-to-noise ratio of a speech signal captured by the third pickup unit, that is, in the low-noise environment, a human voice in the speech signal captured by the second pickup unit is clearer. In a high-noise environment, a signal-to-noise ratio of a speech signal captured by the third pickup unit is higher than a signal-to-noise ratio of a speech signal captured by the second pickup unit, that is, in the high-noise environment, a human voice in the speech signal captured by the third pickup unit is clearer. In a possible embodiment, the second pickup unit is an air conduction microphone, and the third pickup unit is a bone conduction microphone. In another possible embodiment, the second pickup unit is an omnidirectional air conduction microphone, and the third pickup unit is a directional air conduction microphone.

A speech signal captured by the first pickup unit in real time is referred to as a first speech signal, and the first speech signal includes an environmental noise signal. A speech signal captured by the second pickup unit in real time is referred to as a second speech signal. A speech signal captured by the third pickup unit in real time is referred to as a third speech signal. The second pickup unit and the third pickup unit are primary microphones, that is, the second speech signal and the third speech signal are used to perform the voice service. In this embodiment, the first pickup unit is a secondary microphone, and the first speech signal captured by the first pickup unit is mainly used to analyze an environmental noise status. The environmental noise status may be used to determine which of the second speech signal and the third speech signal is used to perform the voice service, so as to implement adaptive switching between speech signals. When the voice service is performed, at most one of the second speech signal and the third speech signal is used for processing simultaneously. When a preset speech switching condition is met, the speech signal currently used to perform the voice service may be switched from one speech signal to the other speech signal.

When the first pickup unit is a pickup unit on the wearable device 201, in a possible embodiment, the first pickup unit and the second pickup unit may be a same pickup unit, and the first speech signal and the second speech signal are a same speech signal. Therefore, a quantity of pickup units on the wearable device 201 can be reduced, and costs of the wearable device 201 can be reduced.

When the first pickup unit is a pickup unit on the wearable device 201, in another possible embodiment, the first pickup unit, the second pickup unit, and the third pickup unit on the wearable device 201 are three different pickup units. Because the first pickup unit dedicated to capturing environmental noise is disposed, accuracy of estimating energy of the environmental noise based on the first speech signal can be improved, it is ensured that a timing for speech switching can be accurately determined in time, and speech switching efficiency is improved. In some embodiments, a microphone with sensitivity lower than that of the second pickup unit may be selected as the first pickup unit, to reduce impact of a user speech signal in the first speech signal, and increase a ratio of environmental noise, so that the first speech signal can more accurately represent the environmental noise status. FIG. 3 is a diagram of a wearable device according to this application. In FIG. 3, an example in which the wearable device is a headset is used. It may be understood that a form of the headset herein is merely used as an example. The headset may alternatively be in another form, for example, may be an in-ear type or a neckband type. The second pickup unit and the third pickup unit may be disposed close to the user and positioned near a vocal organ of the user, so that the second pickup unit and the third pickup unit can more clearly capture speech signals of the user, thereby increasing a signal-to-noise ratio of the second speech signal and a signal-to-noise ratio of the third speech signal. A location and an orientation of the first pickup unit on the wearable device 201 may be properly designed. For example, the first pickup unit is disposed on an outer side of the wearable device 21, and the first pickup unit faces away from the user, so that when the user wears the wearable device, the first pickup unit is relatively far away from the user sound source and can better capture environmental noise signals while minimizing the capture of speech signals of the user. FIG. 3 shows only possible disposition manners of the first pickup unit, the second pickup unit, and the third pickup unit of the wearable device 201, and the disposition manners should not be construed as a limitation on this application. An actual embodiment may depend on a product form of the wearable device 201.

In a possible embodiment, the wearable device 201 may determine, in real time based on the first speech signal, whether the speech switching condition is currently met, and when the speech switching condition is currently met, determine to switch to using the other of the second speech signal and the third speech signal to perform the voice service. In this case, after determining to switch the speech signal used to perform the voice service, the wearable device 201 may send, to the intelligent device 202, only the speech signal used to perform the voice service after the switching, without sending the speech signal used to perform the voice service before the switching; and the intelligent device 202 performs the voice service by using the speech signal obtained through switching. In this case, both the second pickup unit and the third pickup unit may be in an enabled state, that is, both the second pickup unit and the third pickup unit still capture speech signals in real time, but the wearable device 201 sends only the speech signal obtained through switching to the intelligent device 202. Alternatively, after determining to switch the speech signal used to perform the voice service, the wearable device 201 disables a pickup unit corresponding to the speech signal used to perform the voice service before the switching, and enables a pickup unit corresponding to the speech signal used to perform the voice service after the switching, thereby enabling one of the second pickup unit and the third pickup unit, and temporarily disabling the other pickup unit that is currently not required, so that power consumption of the wearable device 201 can be reduced. Certainly, the wearable device 201 may further simultaneously send the first speech signal and the second speech signal to the intelligent device 202. After determining to switch the speech signal used to perform the voice service, the wearable device 201 may send a switching instruction to the intelligent device 202, and the intelligent device 202 switches, according to the switching instruction, the speech signal used to perform the voice service, and performs the voice service by using the speech signal obtained through switching.

In another possible embodiment, the intelligent device 202 may determine, in real time based on the first speech signal, whether the speech switching condition is currently met. When the first pickup unit is a pickup unit on the wearable device 201, the wearable device sends the first speech signal to the intelligent device 202 in real time. When the first pickup unit is a pickup unit on the intelligent device 202, the intelligent device 202 captures the first speech signal in real time by using the first pickup unit. When the intelligent device 202 determines whether the speech switching condition is currently met, the wearable device 201 may simultaneously send the first speech signal and the second speech signal to the intelligent device 202. When determining that the speech switching condition is currently met, the intelligent device 202 determines to switch to using the other of the second speech signal and the third speech signal to perform the voice service, and performs the voice service by using the speech signal obtained through switching. Because the speech signal used to perform the voice service is switched at a back end (the intelligent device 202), a switching delay can be reduced, and a voice stutter and discontinuity caused by the switching can be mitigated. Alternatively, when the intelligent device 202 determines whether the speech switching condition is currently met, when determining that the speech switching condition is currently met, the intelligent device 202 sends a switching instruction to the wearable device 201, and the wearable device 201 sends only the speech signal obtained through switching to the intelligent device 202.

A specific embodiment of determining, in real time based on the first speech signal, whether the speech switching condition is currently met is described in the following method embodiment.

At least two different pickup units are disposed on the wearable device 201, so that when the environmental noise changes, an appropriate speech signal can be adaptively adjusted to perform the voice service. This can ensure that a speech signal with a higher signal-to-noise ratio and greater clarity can be used to perform the voice service regardless of the high-noise environment or the low-noise environment, or when the environmental noise status changes sharply, thereby improving quality of the voice service.

It should be noted that the system architecture and the service scenario described in embodiments of this application are intended to describe the technical solutions in embodiments of this application more clearly, and do not constitute any limitation on the technical solutions provided in embodiments of this application. A person of ordinary skill in the art may know that, with evolution of the system architecture and emergence of a new service scenario, the technical solutions provided in embodiments of this application are also applicable to similar technical problems.

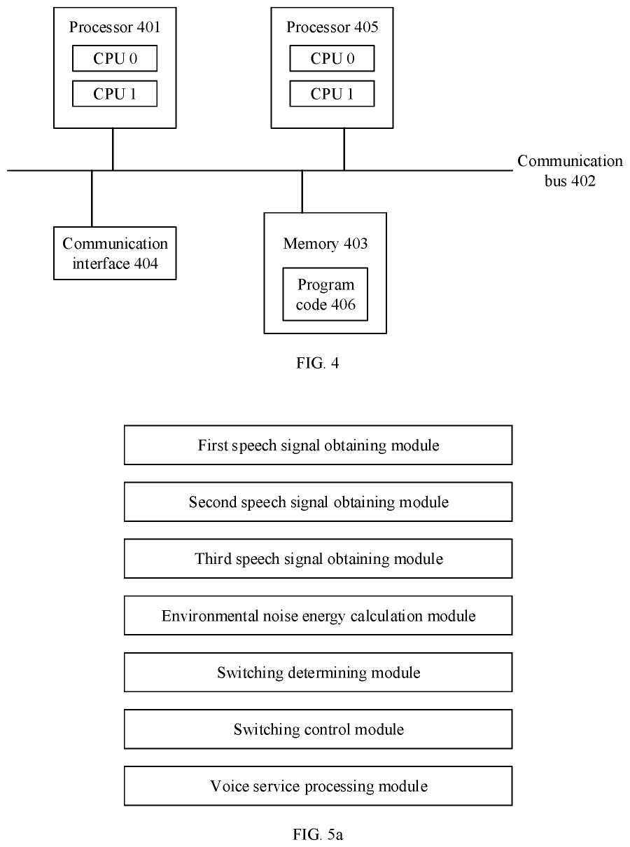

FIG. 4 is a diagram of a structure of an electronic device according to this application. In some embodiments, the electronic device is the wearable device 201 or the intelligent device 202 shown in FIG. 2. The electronic device includes one or more processors 401, a communication bus 402, a memory 403, and one or more communication interfaces 404.

The processor 401 is a general-purpose central processing unit (CPU), a network processor (NP), a microprocessor, or one or more integrated circuits configured to implement the solutions of this application, for example, an application-specific integrated circuit (ASIC), a programmable logic device (PLD), or a combination thereof. In some embodiments, the PLD is a complex programmable logic device (CPLD), a field-programmable gate array (FPGA), generic array logic (GAL), or any combination thereof.

The communication bus 402 is configured to transfer information between the components. In some embodiments, the communication bus 402 may be classified into an address bus, a data bus, a control bus, or the like. For ease of representation, only one thick line is used to represent the bus in the figure, but this does not mean that there is only one bus or only one type of bus.

In some embodiments, the memory 403 is a read-only memory (ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, or the like), a magnetic disk storage medium, or other magnetic storage devices, or any other medium that can be used to carry or store desired program code in a form of an instruction or a data structure and can be accessed by a computer, but is not limited thereto. The memory 403 exists independently, and is connected to the processor 401 through the communication bus 402, or the memory 403 is integrated with the processor 401.

The communication interface 404 is any apparatus such as a transceiver, and is configured to communicate with another device or a communication network. The communication interface 404 includes a wired communication interface, and in some embodiments further includes a wireless communication interface. The wired communication interface is, for example, an Ethernet interface. In some embodiments, the Ethernet interface is an optical interface, an electrical interface, or a combination thereof. The wireless communication interface is a wireless local area network (WLAN) interface, a Bluetooth™ interface, a ZigBee™ interface, an NFC interface, a NearLink™ interface, a cellular network communication interface, or a combination thereof, or the like.

In some embodiments, in some embodiments, the electronic device includes a plurality of processors, for example, the processor 401 and a processor 405 shown in FIG. 4. Each of these processors is a single-core processor or a multi-core processor. In some embodiments, the processor herein is one or more devices, circuits, and/or processing cores configured to process data (for example, computer program instructions).

When the electronic device is the wearable device 201 shown in FIG. 2, the electronic device further includes a second pickup unit (not shown in the figure) and a third pickup unit (not shown in the figure). The second pickup unit is configured to capture a second speech signal, and the third pickup unit is configured to capture a third speech signal. The communication interface 404 is configured to send the second speech signal and/or the third speech signal to an intelligent device. In some embodiments, the electronic device may further include a first pickup unit, and the first pickup unit is configured to capture a first speech signal. Therefore, the electronic device can determine, based on the first speech signal, whether a speech switching condition is currently met, to determine whether to switch a speech signal used to perform a voice service from the second speech signal to the third speech signal or from the third speech signal to the second speech signal. In some embodiments, the communication interface 404 is further configured to send the first speech signal to the intelligent device. Therefore, the intelligent device can determine, based on the first speech signal, whether the speech switching condition is currently met, to determine whether to switch the speech signal used to perform the voice service from the second speech signal to the third speech signal or from the third speech signal to the second speech signal.

When the electronic device is the intelligent device 202 shown in FIG. 2, in some embodiments, the electronic device further includes an output device (not shown in the figure) and an input device (not shown in the figure). The output device communicates with the processor and can display information in a plurality of manners. For example, the output device is a liquid crystal display (LCD), a light emitting diode (LED) display device, a cathode ray tube (CRT) display device, or a projector. The input device communicates with the processor, and can receive an input of a user in a plurality of manners. For example, the input device includes one or more of a mouse, a keyboard, a touchscreen device, or a sensing device. The communication interface 404 is configured to receive a second speech signal and/or a third speech signal sent by a wearable device. In some embodiments, the communication interface 404 is configured to receive a first speech signal sent by the wearable device. In some embodiments, the electronic device may further include a first pickup unit, and the first pickup unit is configured to capture a first speech signal. Therefore, the intelligent device can determine, based on the first speech signal, whether a speech switching condition is currently met, to determine whether to switch a speech signal used to perform a voice service from the second speech signal to the third speech signal or from the third speech signal to the second speech signal.

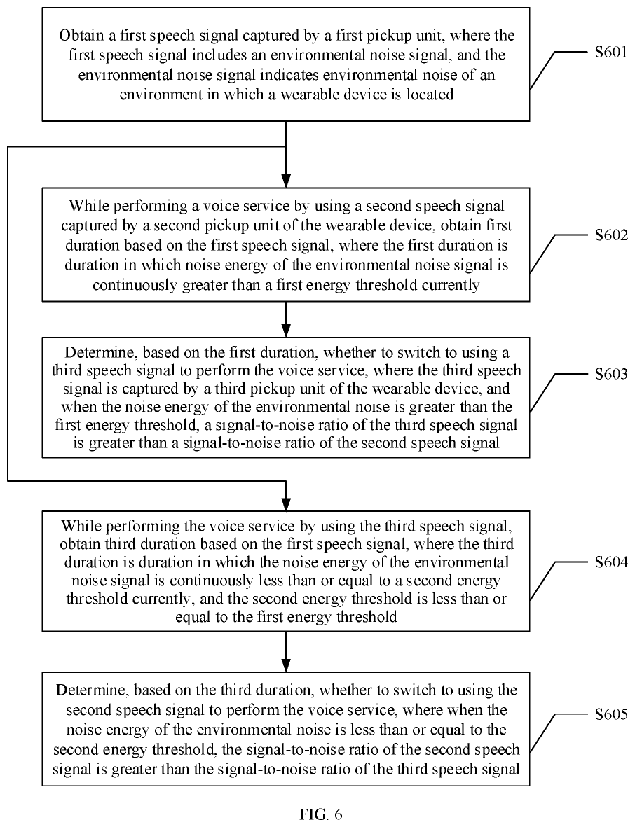

In some embodiments, the memory 403 is configured to store program code 406 for performing the solutions of this application, and the processor 401 can execute the program code 406 stored in the memory 403. The program code 406 includes one or more software modules. The electronic device can implement, by using the processor 401 and the program code 406 in the memory 403, a speech signal processing method provided in the following embodiment in FIG. 6.

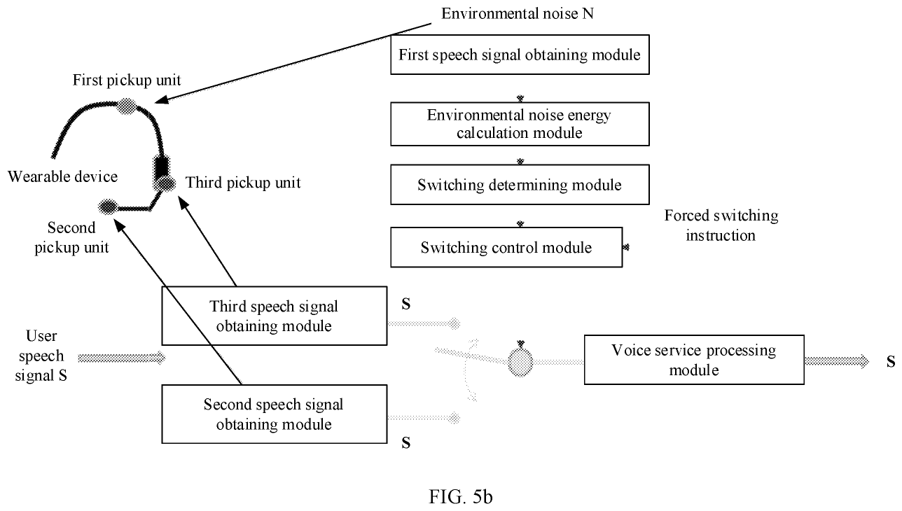

FIG. 5a is a diagram of a logical structure of an electronic device according to this application. FIG. 5b is a diagram of interaction between modules in FIG. 5a. In an embodiment, the electronic device includes a first speech signal obtaining module, a second speech signal obtaining module, a third speech signal obtaining module, an environmental noise energy calculation module, a switching determining module, a switching control module, and a voice service processing module.

The first speech signal obtaining module is configured to obtain a first speech signal captured by a first pickup unit in real time. The second speech signal obtaining module is configured to obtain a second speech signal captured by a second pickup unit in real time. The third speech signal obtaining module is configured to obtain a third speech signal captured by a third pickup unit in real time.

The environmental noise energy calculation module is configured to calculate noise energy of an environmental noise signal in the first speech signal in real time based on the first speech signal.

While a voice service is performed by using the second speech signal currently, the switching determining module is configured to: after noise energy is obtained each time, compare the noise energy with a first noise threshold, and measure first duration in which the noise energy is continuously greater than the first noise threshold. In a possible embodiment, the switching determining module compares the first duration with a first duration threshold, and when the first duration is greater than the first duration threshold, determines to switch to using the third speech signal to perform the voice service, and generates a switching instruction. In another possible embodiment, the switching determining module compares the first duration with the first duration threshold, further compares second duration with a second duration threshold, and when the first duration is greater than the first duration threshold and the second duration is greater than the second duration threshold, determines to switch to using the third speech signal to perform the voice service. The second duration is duration in which the voice service is continuously performed by using the second speech signal currently, and a switching instruction is generated.

While the voice service is performed by using the third speech signal currently, the switching determining module is configured to: after noise energy is obtained each time, compare the noise energy with a second noise threshold, and measure third duration in which the noise energy is continuously greater than the second noise threshold. In a possible embodiment, the switching determining module compares the third duration with a third duration threshold, and when the third duration is greater than the third duration threshold, determines to switch to using the second speech signal to perform the voice service, and generates a switching instruction. In another possible embodiment, the switching determining module compares the third duration with the third duration threshold, further compares fourth duration with a fourth duration threshold, and when the third duration is greater than the third duration threshold and the fourth duration is greater than the fourth duration threshold, determines to switch to using the second speech signal to perform the voice service. The fourth duration is duration in which the voice service is continuously performed by using the third speech signal currently, and a switching instruction is generated.

The switching control module switches, according to the switching instruction, the speech signal used to perform the voice service from the second speech signal to the third speech signal, or switches the speech signal used to perform the voice service from the third speech signal to the second speech signal.

The voice service processing module is configured to perform the voice service based on the speech signal obtained through switching. The voice service processing module may perform processing such as noise reduction, echo reduction, and encoding on the speech signal, and then perform the corresponding voice service based on the processed speech signal.

FIG. 6 is a schematic flowchart of a speech signal processing method according to this application. This embodiment is performed by the electronic device in FIG. 4. The electronic device may be the wearable device in FIG. 2, or may be the intelligent device in FIG. 2. This embodiment includes the following operations.

S601: Obtain a first speech signal captured by a first pickup unit, where the first speech signal includes an environmental noise signal, and the environmental noise signal indicates environmental noise of an environment in which a wearable device is located.

The first pickup unit may be a pickup unit on the wearable device, or may be a pickup unit on an intelligent device connected to the wearable device. The first pickup unit is a pickup unit configured to capture the environmental noise of the environment in which the wearable device is located. Therefore, the first speech signal captured by the first pickup unit includes the environmental noise signal. The first speech signal is a speech signal captured by the first pickup unit in real time, and the electronic device also performs noise analysis on a speech signal newly captured by the first pickup unit in real time.

In a possible embodiment, the first speech signal may be used as the environmental noise signal.

In another possible embodiment, a non-speech segment in the first speech signal may be extracted as an environmental sound signal. For example, the non-speech segment in the first speech signal may be extracted by using voice activity detection (VAD). Therefore, the environmental sound signal can more accurately represent a noise status in the environment, and accuracy and efficiency of making a speech switching decision are ensured.

S602: While performing a voice service by using a second speech signal captured by a second pickup unit of the wearable device, obtain first duration based on the first speech signal, where the first duration is duration in which noise energy of the environmental noise signal is continuously greater than a first energy threshold currently.

The first duration is obtained based on the first speech signal while the voice service is performed by using the second speech signal. The first duration is the duration in which the noise energy of the environmental noise signal is continuously greater than the first energy threshold currently.

The electronic device calculates noise energy of a latest environmental noise signal, determines whether the noise energy is greater than a first noise threshold, and when the noise energy is greater than the first noise threshold, records first duration in time domain in which the noise energy of the environmental noise signal is continuously greater than the first energy threshold up to the present.

Specifically, the electronic device divides the environmental noise signal into frames in time domain, and then calculates noise energy of each frame of the environmental noise signal. The noise energy may be a square value of an amplitude of the frame of the environmental noise signal. In another embodiment, the noise energy may alternatively be a parameter representing environmental noise strength, for example, loudness, power, sound intensity, or sound pressure of the noise. The noise energy of each frame is compared with the first energy threshold, and if the noise energy of the frame is greater than the first energy threshold, a value of a first counter is increased by 1. If the noise energy of the frame is less than or equal to the first energy threshold, the value of the first counter is cleared. It should be noted that the first counter needs to perform counting based on a time sequence of frames. For example, in a group of consecutive frames in time domain (frame 1, frame 2, frame 3, and frame 4), frame 1 is the earliest frame in time domain, and frame 4 is the latest frame in time domain. If noise energy of frame 1 is greater than the first energy threshold, the value of the first counter is increased by 1. If noise energy of frame 2 is greater than the first energy threshold, the value of the first counter is increased by 1. If noise energy of frame 3 is less than the first energy threshold, the value of the first counter is cleared, and the first duration is 0 in this case. If noise energy of frame 4 is greater than the first energy threshold, the value of the first counter is increased by 1, and the value of the first counter is 1 in this case.

Certainly, the duration in which the noise energy of the environmental noise signal is continuously greater than the first energy threshold may alternatively be accumulated duration in which the noise energy of the environmental noise signal is greater than the first energy threshold in time domain within a sliding time window.

S603: Determine, based on the first duration, whether to switch to using a third speech signal to perform the voice service, where the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

The first duration is a key condition for determining whether to switch the speech signal used to perform the voice service to the third speech signal. If the first duration is greater than a first duration threshold, it indicates that the environmental noise is currently in a relatively stable high-noise state. This can avoid impact of frequent switching between speech signals on voice continuity in a case of complex environmental noise.

In a possible embodiment, the first duration being greater than the first duration threshold may be used as a unique condition for determining that a speech switching condition is currently met. Specifically, the electronic device determines whether the first duration is greater than the first duration threshold, and when the first duration is greater than the first duration threshold, determines to switch to using the third speech signal to perform the voice service. When the first duration is less than or equal to the first duration threshold, the electronic device determines to still use the second speech signal to perform the voice service. In a possible embodiment, a current value m (m is a natural number, indicating that noise energy of m consecutive frames in time domain is greater than the first energy threshold, and because duration of a frame is fixed, the value m may represent the first duration) of the first counter may be compared with a first preset value n (n is a positive integer, and n represents a threshold for a quantity of consecutive frames whose noise energy is greater than the first energy threshold, and because duration of a frame is fixed, n can also represent the first duration threshold). When m is greater than n, it may be considered that the first duration is greater than the first duration threshold. When m is less than or equal to n, it may be considered that the first duration is less than or equal to the first duration threshold.

In another possible embodiment, the first duration being greater than the first duration threshold and second duration being greater than a second duration threshold may be used as a speech switching condition. The second duration is duration in which the voice service is continuously performed by using the second speech signal currently. In some embodiments, the second duration threshold is greater than the first duration threshold. The second duration threshold may be considered as switching protection duration. To be specific, after the speech signal is switched, the speech signal obtained through switching needs to be continuously used for duration greater than the second duration threshold before the speech signal is allowed to be switched again, to avoid impact of frequent switching between speech signals on quality of the voice service. Specifically, the electronic device compares the first duration with the first duration threshold, and compares the second duration with the second duration threshold. When the first duration is greater than the first duration threshold, and the second duration is greater than the second duration threshold, the electronic device may consider that the speech switching condition is currently met, and determine to switch to using the third speech signal to perform the voice service. When the first duration is less than or equal to the first duration threshold, and/or the second duration is less than or equal to the second duration threshold, the electronic device may consider that the speech switching condition is not met currently, and determine to still use the second speech signal to perform the voice service.

The first duration threshold is used to ensure that the speech signal is not switched merely because noise energy of a frame is greater than the first energy threshold, thereby ensuring stability and continuity of the voice service. The second duration threshold can ensure that, after switching to using the second speech signal to perform the voice service, the electronic device does not immediately switch to the third speech signal within a short period of time, thereby ensuring stability and continuity of the voice service.

In this embodiment, when the noise energy of the environmental noise is greater than the first energy threshold, the signal-to-noise ratio of the third speech signal is greater than the signal-to-noise ratio of the second speech signal. In other words, in a relatively noisy environment, the speech signal used to perform the voice service is switched to a speech signal with a higher signal-to-noise ratio in the current environment, thereby ensuring that the speech signal is still clear in a high-noise environment, and ensuring quality of the voice service.

S604: While performing the voice service by using the third speech signal, obtain third duration based on the first speech signal, where the third duration is duration in which the noise energy of the environmental noise signal is continuously less than or equal to a second energy threshold currently, and the second energy threshold is less than or equal to the first energy threshold.

The third duration is obtained based on the first speech signal while the voice service is performed by using the third speech signal. The third duration is duration in which the noise energy of the environmental noise signal is continuously less than or equal to the second energy threshold currently.

The electronic device calculates noise energy of a latest environmental noise signal, determines whether the noise energy is less than or equal to the second energy threshold, and when the noise energy is less than or equal to the second energy threshold, records third duration in time domain in which the noise energy of the environmental noise signal is continuously less than or equal to the second energy threshold up to the present.

Specifically, the electronic device divides the environmental noise signal into frames in time domain, and then calculates noise energy of each frame of the environmental noise signal. The noise energy is a square of an amplitude of the environmental noise signal of the frame. The noise energy of each frame is compared with the second energy threshold, and if the noise energy of the frame is less than or equal to the second energy threshold, a value of a second counter is increased by 1. If the noise energy of the frame is greater than the second energy threshold, the value of the second counter is cleared. It should be noted that the second counter needs to perform counting based on a time sequence of frames.

Certainly, the duration in which the noise energy of the environmental noise signal is continuously less than or equal to the second energy threshold may alternatively be accumulated duration in which the noise energy of the environmental noise signal is less than or equal to the second energy threshold in time domain within the sliding time window.

In this embodiment, the second energy threshold is less than or equal to the first energy threshold. The first duration threshold may be the same as or different from a third duration threshold. The second duration threshold may be the same as or different from a fourth duration threshold.

S605: Determine, based on the third duration, whether to switch to using the second speech signal to perform the voice service, where when the noise energy of the environmental noise is less than or equal to the second energy threshold, the signal-to-noise ratio of the second speech signal is greater than the signal-to-noise ratio of the third speech signal.

The third duration is a key condition for determining whether to switch the speech signal used to perform the voice service to the second speech signal. If the second duration is greater than the first duration threshold, it indicates that the environmental noise is currently in a relatively stable low-noise state. This can avoid impact of frequent switching between speech signals on voice continuity in a case of complex environmental noise.

In a possible embodiment, the third duration being greater than the third duration threshold may be used as a unique condition for determining that the speech switching condition is currently met. Specifically, the electronic device determines whether the third duration is greater than the third duration threshold, and when the third duration is greater than the third duration threshold, determines to switch to using the second speech signal to perform the voice service. When the third duration is less than or equal to the third duration threshold, the electronic device determines to still use the third speech signal to perform the voice service. In a possible embodiment, a current value p (p is a natural number, indicating that noise energy of p consecutive frames in time domain is less than or equal to the second energy threshold, and because duration of a frame is fixed, the value p may represent the third duration) of the second counter may be compared with a second preset value q (q is a positive integer, and q represents a threshold for a quantity of consecutive frames whose noise energy is less than or equal to the second energy threshold, and because duration of a frame is fixed, q can also represent the third duration threshold). When p is greater than q, it may be considered that the third duration is greater than the third duration threshold. When p is less than or equal to q, it may be considered that the third duration is less than or equal to the third duration threshold.

In another possible embodiment, the third duration being greater than the third duration threshold and fourth duration being greater than the fourth duration threshold may be used as a speech switching condition. The fourth duration is duration in which the voice service is continuously performed by using the third speech signal currently. In some embodiments, the fourth duration threshold is greater than the third duration threshold. The fourth duration threshold may be considered as switching protection duration. To be specific, after the speech signal is switched, the speech signal obtained through switching needs to be continuously used for duration greater than the fourth duration threshold before the speech signal is allowed to be switched again, to avoid impact of frequent switching between speech signals on quality of the voice service. Specifically, the electronic device compares the third duration with the third duration threshold, and compares the fourth duration with the fourth duration threshold. When the third duration is greater than the third duration threshold, and the fourth duration is greater than the fourth duration threshold, the electronic device may consider that the speech switching condition is currently met, and determine to switch to using the third speech signal to perform the voice service. When the third duration is less than or equal to the third duration threshold, and/or the fourth duration is less than or equal to the fourth duration threshold, the electronic device may consider that the speech switching condition is not met currently, and determine to still use the third speech signal to perform the voice service.

The third duration threshold is used to ensure that the speech signal is not switched merely because noise energy of a frame is less than or equal to the second energy threshold, thereby ensuring stability and continuity of the voice service. The fourth duration threshold can ensure that, after switching to using the third speech signal to perform the voice service, the electronic device does not immediately switch to the second speech signal within a short period of time, thereby ensuring stability and continuity of the voice service.

In this embodiment, when the noise energy of the environmental noise is less than or equal to the second energy threshold, the signal-to-noise ratio of the second speech signal is greater than the signal-to-noise ratio of the third speech signal. In other words, in a low-noise environment, the speech signal used to perform the voice service is switched to a speech signal with a higher signal-to-noise ratio in the current environment, thereby ensuring that the speech signal is still clear in a high-noise environment, and ensuring quality of the voice service.

In this embodiment, at least two different pickup units are disposed on the wearable device. The second pickup unit has a higher signal-to-noise ratio in a low-noise environment, and the third pickup unit has a higher signal-to-noise ratio in a high-noise environment. Duration in which the current environment is continuously in a state is obtained based on the environmental noise signal, whether the current environment is a high-noise environment or a low-noise environment is determined based on the duration, and further, the speech signal used to perform the voice service is adaptively switched. In addition, bidirectional switching is supported, to ensure a relatively high signal-to-noise ratio of each speech signal and speech clarity and reliability in a complex environment, and ensure stability of the voice service. Further, in this embodiment, a switching protection time interval is also set, to avoid impact of frequent switching between speech signals on quality of the voice service. In addition, in this embodiment, no complex noise reduction algorithm is required. In other words, it can be ensured that the voice service can be processed based on a speech signal with a high signal-to-noise ratio in all scenarios, a requirement on computing power of the electronic device can be reduced, and a requirement on a noise reduction algorithm can be reduced, so that stability of the voice service can be ensured at low costs.

In some embodiments, the electronic device has an adaptive switching function (that is, the method in FIG. 6) and a forced switching function. When the forced switching function is enabled and the adaptive switching function is disabled, the speech signal used to perform the voice service is switched according to a forced switching instruction. When the forced switching instruction is enabled and the adaptive switching function is enabled, the forced switching instruction is preferentially executed. Specifically, when a user issues a forced switching instruction due to an actual requirement, the forced switching instruction instructs to switch to a target speech signal of the first speech signal and the second speech signal, and the forced switching instruction is preferentially executed; and when the speech signal currently used to perform the voice service is inconsistent with the target speech signal, instructs to switch to using the target speech signal to perform the voice service. After forced switching is performed, when the switching condition is met, the speech signal is switched according to an adaptive switching instruction. When the forced function is disabled and the adaptive switching function is enabled, the speech signal is switched only according to the adaptive switching instruction. When both the forced switching function and the adaptive switching function are disabled, the current speech signal is still used to perform the voice service, and no switching is performed.

In some embodiments, the foregoing describes how to adaptively switch, in the voice service, the speech signal used to perform the voice service. When the voice service starts, an initial speech signal used to perform the voice service may be selected by using the following method. For example, a default initial speech signal may be set, and when the voice service starts, the default speech signal is used to perform the voice service. The default initial speech signal may be the second speech signal or the third speech signal. For another example, a specific speech signal used to perform the voice service may be determined based on noise energy of the environmental noise signal when the service starts. Specifically, when initial noise energy of the environmental noise signal is greater than a third energy threshold, the third speech signal is selected to perform the voice service; or when initial noise energy is less than or equal to a third energy threshold, the second speech signal is selected to perform the voice service. The third energy threshold may be greater than or equal to the second energy threshold, and less than or equal to the first energy threshold. Certainly, the third energy threshold may alternatively be greater than the first energy threshold, or less than the second energy threshold. This is not limited herein.

In some embodiments, when the second speech signal is used to perform the voice service, noise reduction processing may be performed on the second speech signal by using the first speech signal. Noise reduction processing performed on the second speech signal by using the first speech signal is shown in the following formula. The processing is performed in frequency domain. To be specific, fast Fourier transform (FFT) is first performed on y (the first speech signal) and x (the second speech signal) to transform them into frequency domain, and then processing is performed in frequency domain. It may be understood that, when the first speech signal and the second speech signal are processed, each frame of data obtained by performing frame division and windowing respectively on the first speech signal and the second speech signal is processed.

$$s ( w ) = x ( w ) - y ( w ) \cdot ( smooth \frac{y ( w ) \cdot x ( w )}{y ( w ) \cdot y ( w )} ) ,$$

s(w) is a denoised speech signal after noise reduction, and is a frequency-domain signal. x(w) is a frequency-domain signal corresponding to the second speech signal, and y(w) is a frequency-domain signal corresponding to the first speech signal.

$$smooth \frac{y ( w ) \cdot x ( w )}{y ( w ) \cdot y ( w )}$$

represents a correlated frequency-domain signal between x(w) and y(w). The meaning of this formula is to subtract, from x(w), a frequency-domain signal (that is, a frequency-domain signal of noise) that is in y(w) and that is correlated with x(w), to obtain the denoised speech signal in frequency domain.

In other words, a part that is in the second speech signal and that strongly correlated with the first speech signal is filtered out. Because the first speech signal is mainly a noise signal, and the first speech signal and the second speech signal are speech signals captured in the same environment, the part that is in the second speech signal and that is strongly correlated with the first speech signal may be considered as noise. After the noise is filtered out, the remaining signal s(w) is mainly a human speech signal with a higher signal-to-noise ratio and is used as the denoised speech signal for subsequent service processing.

In a call service scenario, subsequent service processing includes, for example, acoustic processing such as echo cancellation and reverberation cancellation. A speech signal obtained by performing a series of acoustic processing is encoded and then is sent to a peer end through a wireless network. In a recording service scenario, subsequent service processing includes, for example, storing a denoised speech signal. In a voice interaction scenario, subsequent processing includes, for example, performing speech recognition processing on a denoised speech signal and performing a related task.

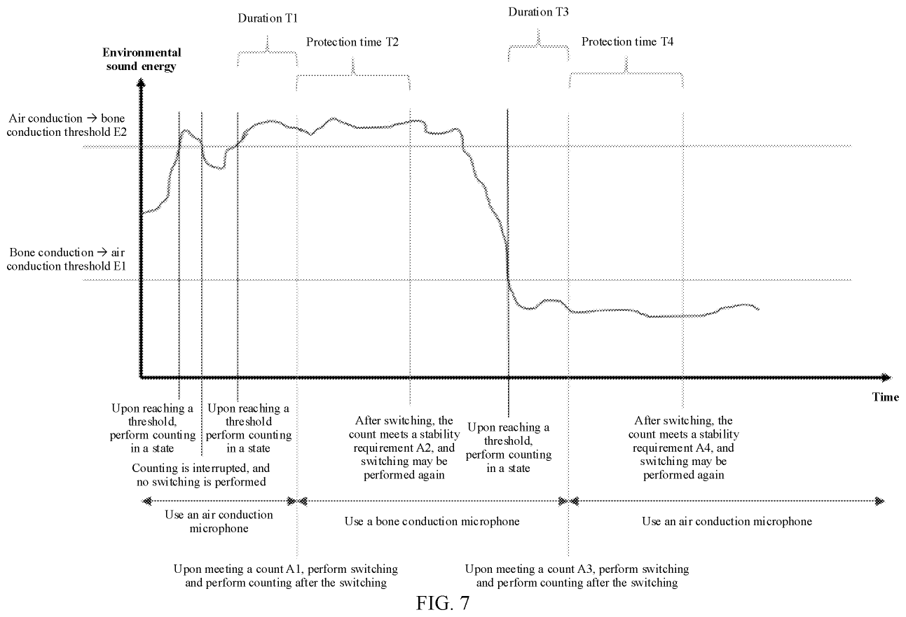

To make this solution more comprehensible, an example is shown in FIG. 7. FIG. 7 is a simulation diagram of speech switching performed based on a solution provided in this application, according to this application. In FIG. 7, an example in which a first pickup unit is an air conduction microphone and a second pickup unit is a bone conduction microphone is used. A first energy threshold is E2, a second energy threshold is E1, and a voice service is performed by using a speech signal captured by the air conduction microphone when the voice service starts. Duration T1 is a first duration threshold, a protection time T2 is a second duration threshold, duration T3 is a third duration threshold, and a protection time T4 is a fourth duration threshold. It can be learned that after first duration in which noise energy (environmental sound energy) of an environmental noise signal reaches the threshold E2 (a quantity of consecutive frames whose environmental sound energy is greater than the threshold E2 in time domain meets a count A1) is greater than the duration T1, switching is performed to use a speech signal captured by the bone conduction microphone to perform the voice service. After the switching to the bone conduction microphone, when second duration (a count A2 is met) in which the speech signal captured by the bone conduction microphone is continuously used to perform the voice service is greater than the protection time T2, switching to the air conduction microphone may be allowed. However, in this case, an environmental sound energy condition is not met, and the speech signal captured by the bone conduction microphone is still used to perform the voice service. When there is a frame whose environmental sound energy is less than the threshold E1, a quantity of consecutive frames whose environmental sound energy is less than the threshold E1 starts to be counted. When third duration (a count A3 is met) is reached, switching is performed to use the speech signal captured by the air conduction microphone to perform the voice service. After the switching to the air conduction microphone, when fourth duration (a count A4 is met) in which the speech signal captured by the air conduction microphone is continuously used to perform the voice service is greater than the protection time T4, switching to the bone conduction microphone may be allowed. However, in this case, the environmental sound energy condition is not met, and the speech signal captured by the air conduction microphone is still used to perform the voice service.

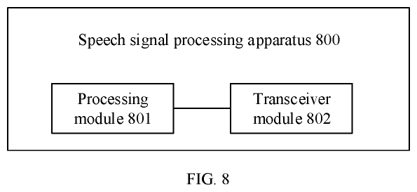

Based on a same inventive concept, as shown in FIG. 8, this application further provides a speech signal processing apparatus. The speech signal processing apparatus 800 includes a processing module 801. The speech signal processing apparatus 800 may be applied to a wearable device, such as a headset, smart glasses, an AR head mounted display device, a VR head mounted display device, or a neck massage apparatus. The speech signal processing apparatus 800 may be a wearable device, or may be a functional module or a hardware module (such as a chip) in a wearable device. The speech signal processing apparatus 800 may be applied to an intelligent device, for example, may be a device such as a mobile phone, a tablet computer, a computer, or in-vehicle infotainment. The speech signal processing apparatus 800 may be an intelligent device, or may be a functional module or a hardware module (such as a chip) in an intelligent device.

The processing module 801 is configured to obtain a first speech signal captured by a first pickup unit, where the first speech signal includes an environmental noise signal, and the environmental noise signal indicates environmental noise of an environment in which a wearable device is located. The first pickup unit is a pickup unit configured to capture environmental noise, and the environmental noise in the first speech signal can accurately represent an environmental noise status of the environment in which the wearable device is located. While performing a voice service by using a second speech signal captured by a second pickup unit of the wearable device, the processing module is configured to obtain first duration based on the first speech signal, where the first duration is duration in which noise energy of the environmental noise signal is continuously greater than a first energy threshold currently. The processing module is configured to determine, based on the first duration, whether to switch to using a third speech signal to perform the voice service, where the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

In a possible embodiment, the processing module 801 is configured to determine to switch to using the third speech signal to perform the voice service when the first duration is greater than a first duration threshold; or the processing module 801 is configured to determine to still use the second speech signal to perform the voice service when the first duration is less than or equal to a first duration threshold.

In a possible embodiment, the processing module 801 is configured to: determine, based on the first duration and second duration, whether to switch to using the third speech signal to perform the voice service, where the second duration is duration in which the voice service is continuously performed by using the second speech signal currently.

In a possible embodiment, the processing module 801 is configured to determine to switch to using the third speech signal to perform the voice service when the first duration is greater than the first duration threshold, and the second duration is greater than a second duration threshold; or the processing module 801 is configured to determine to still use the second speech signal to perform the voice service when the first duration is less than or equal to the first duration threshold, and/or the second duration is less than or equal to a second duration threshold. In some embodiments, the second duration threshold is greater than the first duration threshold.

In a possible embodiment, the processing module 801 is configured to obtain third duration based on the first speech signal while performing the voice service by using the third speech signal, where the third duration is duration in which the noise energy of the environmental noise signal is continuously less than or equal to a second energy threshold currently, and the second energy threshold is less than or equal to the first energy threshold; and the processing module 801 is configured to determine, based on the third duration, whether to switch to using the second speech signal to perform the voice service, where when the noise energy of the environmental noise is less than or equal to the second energy threshold, the signal-to-noise ratio of the second speech signal is greater than the signal-to-noise ratio of the third speech signal.

In a possible embodiment, the processing module 801 is configured to determine to switch to using the second speech signal to perform the voice service when the third duration is greater than a third duration threshold; or the processing module 801 is configured to determine to still use the third speech signal to perform the voice service when the third duration is less than or equal to a third duration threshold.

In a possible embodiment, the processing module 801 is configured to determine, based on the third duration and fourth duration, whether to switch to using the third speech signal to perform the voice service, where the fourth duration is duration in which the voice service is continuously performed by using the third speech signal currently.

In a possible embodiment, the processing module 801 is configured to determine to switch to using the second speech signal to perform the voice service when the third duration is greater than a third duration threshold, and the fourth duration is greater than a fourth duration threshold; or the processing module 801 is configured to determine to still use the third speech signal to perform the voice service when the third duration is less than or equal to a third duration threshold, and/or the fourth duration is less than or equal to a fourth duration threshold.

In a possible embodiment, the processing module 801 is configured to obtain a forced switching instruction, where the forced switching instruction instructs to use a target speech signal to perform the voice service, and the target speech signal is one of the second speech signal and the third speech signal; and the processing module 801 is configured to switch to using the target speech signal to perform the voice service when a speech signal currently used to perform the voice service is different from the target speech signal.

In a possible embodiment, the processing module 801 is configured to: when the target speech signal is the second speech signal, obtain fifth duration based on the first speech signal, and determine, based on the fifth duration, whether to switch to using the third speech signal to perform the voice service, where the fifth duration is duration in which the noise energy of the environmental noise signal is continuously greater than the first energy threshold currently; or the processing module 801 is configured to: when the target speech signal is the third speech signal, obtain sixth duration based on the first speech signal, and determine, based on the sixth duration, whether to switch to using the second speech signal to perform the voice service, where the sixth duration is duration in which the noise energy of the environmental noise signal is continuously less than or equal to the second energy threshold currently. A combination of forced switching and adaptive switching can meet a user requirement and ensure stability of the voice service.

In a possible embodiment, the processing module 801 is configured to obtain initial noise energy of the environmental noise based on the first speech signal when the voice service starts; and the processing module 801 is configured to determine to use the third speech signal to perform the voice service when the initial noise energy is greater than a fifth energy threshold; or the processing module 801 is configured to determine to use the second speech signal to perform the voice service when the initial noise energy is less than or equal to a fifth energy threshold. When the voice service starts, the speech signal used to perform the voice service is selected based on the initial noise energy. This can ensure that the speech signal has a relatively high signal-to-noise ratio at an initial stage of the voice service, and ensure quality of the voice service.

In a possible embodiment, the processing module 801 is configured to extract a non-speech segment in the first speech signal to obtain the environmental noise signal; and the processing module 801 is configured to obtain the noise energy of the environmental noise signal. A user speech signal may further exist in the first speech signal, and the non-speech segment extracted from the first speech signal is a relatively pure environmental noise signal, so that the environmental noise signal can accurately represent a current environmental noise status. Therefore, making a speech switching decision based on the environmental noise status is more timely and accurate.

In a possible embodiment, the first pickup unit is a pickup unit disposed on the wearable device; or the first pickup unit is a pickup unit disposed on an intelligent device connected to the wearable device.

In a possible embodiment, the processing module 801 is configured to perform noise reduction processing on the second speech signal by using the first speech signal, to obtain a denoised speech signal; and the processing module 801 is configured to perform the voice service by using the denoised speech signal. The first speech signal can accurately represent the current environmental noise status. In addition, because the first speech signal and the second speech signal are captured in the same environment, performing noise reduction processing on the second speech signal by using the first speech signal can filter environmental noise in the second speech signal more accurately, thereby obtaining a denoised speech signal with a higher signal-to-noise ratio, improving speech clarity of the user, and ensuring quality of the voice service.

In a possible embodiment, the second pickup unit is an air conduction microphone, and the third pickup unit is a bone conduction microphone; or the second pickup unit is an omnidirectional air conduction microphone, and the third pickup unit is a directional air conduction microphone.

In some embodiments, the speech signal processing apparatus 800 may further include a transceiver module 802. When the speech signal processing apparatus 800 is applied to the wearable device, the transceiver module 802 is configured to send the second speech signal or the third speech signal to the intelligent device. In some embodiments, the transceiver module 802 is further configured to send the first speech signal to the intelligent device.

When the speech signal processing apparatus 800 is applied to the intelligent device, the transceiver module 802 is configured to receive the second speech signal or the third speech signal sent by the wearable device. In some embodiments, the transceiver module 802 is further configured to receive the first speech signal sent by the wearable device.

This application further provides a computer-readable storage medium. The computer-readable storage medium stores a computer program. When the computer program is executed by a computer, the signal processing method procedure in any method embodiment of this application is implemented.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the foregoing apparatus embodiments are merely examples. For example, division of the units is merely logical function division and may be other division in actual embodiment. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic or other forms.

The units described as separate parts may or may not be physically separate, and parts displayed as units may or may not be physical units, and may be located in one position, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, all of the technical solutions of this application or a part of the technical solutions may be implemented in a form of a computer software product. The computer software product is stored in a storage medium, and includes several instructions for instructing a computer device (which may be a personal computer, a server, a network device, or the like) to perform all or some of the operations of the methods described in embodiments of this application. The storage medium includes any medium that can store program code, for example, a USB flash drive, a removable hard disk, a read-only memory (ROM), a random access memory (RAM), a magnetic disk, or an optical disc.

1. A speech signal processing method, comprising:
obtaining a first speech signal captured by a first pickup unit, wherein the first speech signal comprises an environmental noise signal, and the environmental noise signal indicates environmental noise of an environment in which a wearable device is located;
while performing a voice service using a second speech signal captured by a second pickup unit of the wearable device, obtaining a first duration based on the first speech signal, wherein the first duration is duration in which noise energy of the environmental noise signal is continuously greater than a first energy threshold currently; and
determining, based on the first duration, whether to switch to using a third speech signal to perform the voice service, wherein the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

2. The method according to claim 1, wherein determining, based on the first duration, whether to switch to using the third speech signal to perform the voice service comprises:
when the first duration is greater than a first duration threshold, determining to switch to using the third speech signal to perform the voice service; or
when the first duration is less than or equal to a first duration threshold, determining to still use the second speech signal to perform the voice service.

3. The method according to claim 1, wherein determining, based on the first duration, whether to switch to using the third speech signal to perform the voice service comprises:
determining, based on the first duration and a second duration, whether to switch to using the third speech signal to perform the voice service, wherein the second duration is duration in which the voice service is continuously performed using the second speech signal currently.

4. The method according to claim 3, wherein determining, based on the first duration and the second duration, whether to switch to using the third speech signal to perform the voice service comprises:
when the first duration is greater than a first duration threshold, and the second duration is greater than a second duration threshold, determining to switch to using the third speech signal to perform the voice service; or
when the first duration is less than or equal to a first duration threshold, and/or the second duration is less than or equal to a second duration threshold, determining to still use the second speech signal to perform the voice service.

5. The method according to claim 1, wherein the method further comprises:
while performing the voice service using the third speech signal, obtaining a third duration based on the first speech signal, wherein the third duration is duration in which the noise energy of the environmental noise signal is continuously less than or equal to a second energy threshold currently, and the second energy threshold is less than or equal to the first energy threshold; and
determining, based on the third duration, whether to switch to using the second speech signal to perform the voice service, wherein when the noise energy of the environmental noise is less than or equal to the second energy threshold, the signal-to-noise ratio of the second speech signal is greater than the signal-to-noise ratio of the third speech signal.

6. The method according to claim 5, wherein determining, based on the third duration, whether to switch to using the second speech signal to perform the voice service comprises:
when the third duration is greater than a third duration threshold, determining to switch to using the second speech signal to perform the voice service; or
when the third duration is less than or equal to a third duration threshold, determining to still use the third speech signal to perform the voice service.

7. The method according to claim 5, wherein determining, based on the third duration, whether to switch to using the second speech signal to perform the voice service comprises:
determining, based on the third duration and a fourth duration, whether to switch to using the third speech signal to perform the voice service, wherein the fourth duration is duration in which the voice service is continuously performed using the third speech signal currently.

8. The method according to claim 7, wherein determining, based on the third duration and the fourth duration, whether to switch to using the third speech signal to perform the voice service comprises:
when the third duration is greater than a third duration threshold, and the fourth duration is greater than a fourth duration threshold, determining to switch to using the second speech signal to perform the voice service; or
when the third duration is less than or equal to a third duration threshold, and/or the fourth duration is less than or equal to a fourth duration threshold, determining to still use the third speech signal to perform the voice service.

9. The method according to claim 1, wherein the method further comprises:
obtaining a forced switching instruction, wherein the forced switching instruction instructs to use a target speech signal to perform the voice service, and the target speech signal is one of the second speech signal and the third speech signal; and
when a speech signal currently used to perform the voice service is different from the target speech signal, switching to using the target speech signal to perform the voice service.

10. The method according to claim 9, wherein after switching to using the target speech signal to perform the voice service, the method further comprises:
when the target speech signal is the second speech signal, obtaining fifth duration based on the first speech signal, and determining, based on the fifth duration, whether to switch to using the third speech signal to perform the voice service, wherein the fifth duration is duration in which the noise energy of the environmental noise signal is continuously greater than the first energy threshold currently; or
when the target speech signal is the third speech signal, obtaining sixth duration based on the first speech signal, and determining, based on the sixth duration, whether to switch to using the second speech signal to perform the voice service, wherein the sixth duration is duration in which the noise energy of the environmental noise signal is continuously less than or equal to a second energy threshold currently, and wherein the second energy threshold is less than or equal to the first energy threshold.

11. The method according to claim 1, wherein the method further comprises:
when the voice service starts, obtaining initial noise energy of the environmental noise based on the first speech signal; and
when the initial noise energy is greater than a fifth energy threshold, determining to use the third speech signal to perform the voice service; or
when the initial noise energy is less than or equal to a fifth energy threshold, determining to use the second speech signal to perform the voice service.

12. The method according to claim 1, wherein the method further comprises:
extracting a non-speech segment in the first speech signal to obtain the environmental noise signal; and
obtaining the noise energy of the environmental noise signal.

13. The method according to claim 1, wherein performing the voice service using the second speech signal captured by the second pickup unit of the wearable device comprises:
performing noise reduction processing on the second speech signal using the first speech signal, to obtain a denoised speech signal; and
performing the voice service using the denoised speech signal.

14. An electronic device, wherein the electronic device comprises a processor and a memory, the processor is coupled to the memory, and the processor is configured to perform, based on instructions stored in the memory, speech signal processing that causes the electronic device to:
obtain a first speech signal captured by a first pickup unit, wherein the first speech signal comprises an environmental noise signal, and the environmental noise signal indicates environmental noise of an environment in which a wearable device is located;
while performing a voice service using a second speech signal captured by a second pickup unit of the wearable device, obtain first duration based on the first speech signal, wherein the first duration is duration in which noise energy of the environmental noise signal is continuously greater than a first energy threshold currently; and
determine, based on the first duration, whether to switch to using a third speech signal to perform the voice service, wherein the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

15. The electronic device according to claim 14, wherein the electronic device is caused to determine, based on the first duration, whether to switch to using the third speech signal to perform the voice service further comprises the electronic device caused to:
when the first duration is greater than a first duration threshold, determine to switch to using the third speech signal to perform the voice service; or
when the first duration is less than or equal to a first duration threshold, determine to still use the second speech signal to perform the voice service.

16. The electronic device according to claim 14, wherein the electronic device is caused to determine, based on the first duration, whether to switch to using the third speech signal to perform the voice service further comprises the electronic device caused to:
determine, based on the first duration and a second duration, whether to switch to using the third speech signal to perform the voice service, wherein the second duration is duration in which the voice service is continuously performed using the second speech signal currently.

17. The electronic device according to claim 14, wherein the electronic device is further caused to:
while performing the voice service using the third speech signal, obtain a third duration based on the first speech signal, wherein the third duration is duration in which the noise energy of the environmental noise signal is continuously less than or equal to a second energy threshold currently, and the second energy threshold is less than or equal to the first energy threshold; and
determine, based on the third duration, whether to switch to using the second speech signal to perform the voice service, wherein when the noise energy of the environmental noise is less than or equal to the second energy threshold, the signal-to-noise ratio of the second speech signal is greater than the signal-to-noise ratio of the third speech signal.

18. A non-transitory computer-readable storage medium comprising instructions, wherein when the computer-readable storage medium runs on a computer, the computer is enabled to perform speech signal processing that causes the computer to:
obtain a first speech signal captured by a first pickup unit, wherein the first speech signal comprises an environmental noise signal, and the environmental noise signal indicates environmental noise of an environment in which a wearable device is located;
while performing a voice service using a second speech signal captured by a second pickup unit of the wearable device, obtain first duration based on the first speech signal, wherein the first duration is duration in which noise energy of the environmental noise signal is continuously greater than a first energy threshold currently; and
determine, based on the first duration, whether to switch to using a third speech signal to perform the voice service, wherein the third speech signal is captured by a third pickup unit of the wearable device, and when the noise energy of the environmental noise is greater than the first energy threshold, a signal-to-noise ratio of the third speech signal is greater than a signal-to-noise ratio of the second speech signal.

19. The non-transitory computer-readable storage medium according to claim 18, wherein the computer caused to determine, based on the first duration, whether to switch to using the third speech signal to perform the voice service further comprises the computer caused to:
when the first duration is greater than a first duration threshold, determine to switch to using the third speech signal to perform the voice service; or
when the first duration is less than or equal to a first duration threshold, determine to still use the second speech signal to perform the voice service.

20. The non-transitory computer-readable storage medium according to claim 18, wherein the computer caused to determine, based on the first duration, whether to switch to using the third speech signal to perform the voice service further comprises the computer caused to:
determine, based on the first duration and a second duration, whether to switch to using the third speech signal to perform the voice service, wherein the second duration is duration in which the voice service is continuously performed using the second speech signal currently.
